(19) United States
(12) Patent Application Publication
(10) Pub. No.: US 2007/0016376 A1
(43) Pub. Date: Jan. 18, 2007

(54) Method and device for searching drug binding site of protein

(75) Inventors: Tomoaki Sato, Kawasaki (JP); Hiroyuki Onda, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/288,362

(22) Filed: Nov. 29, 2005

(30) Foreign Application Priority Data
Jul. 13, 2005 (JP) 2005-204959

(51) Int. Cl. G06F 19/00

(52) U.S. Cl. 702/19

(57) ABSTRACT

A search device for searching a specific surface site of protein includes: a database that stores morphology data of first surface sites of a first protein and second surface sites of a second protein; a specifying unit that specifies one of the first surface sites as a drug binding site; and a searching unit that searches one of the second surface sites identical or similar to the drug binding site, as a probable drug binding site based on the morphology data stored in the database.

### CROSS-REFERENCE TO RELATED APPLICATIONS

This application is based upon and claims the benefit of priority from the prior Japanese Patent Application No. 2005-204959, filed on Jul. 13, 2005, the entire contents of which are incorporated herein by reference.

### BACKGROUND OF THE INVENTION

1. Field of the Invention

The present invention relates to a technology for searching a specific surface morphology of protein, such as a drug binding site.

2. Description of the Related Art

Conventionally, there are databases that contain three-dimensional structures of proteins for proteins having a similar structure to an arbitrary protein, an example of which is the PDB (Protein Data Bank; a database containing protein three-dimensional structure data that is jointly operated by the Research Collaboratory for Structural Bioinformatics (RCSB, United States), the European Bioinformatics Institute (EBI), and the Institute for Protein Research, Osaka University of Japan).

A method has been disclosed that predicts the protein scaffolding of a sequence in question by dividing the amino acid sequences of reference proteins, for which the three-dimensional structure is known or able to be predicted, into a core partial sequence substantially involved in hydrophobic core formation and a sub-partial sequence that is not involved, matching each partial sequence, based on environmental information on each amino acid residue of the reference proteins and hydrophobic or hydrophilic properties of the side chains of each amino acid residue in the sequence in question using a database containing environmental information on the side chains of each amino acid residue, and selecting a template protein having a high degree of a three-dimensional structural similarity with a protein of the sequence in question from among the reference proteins (see International Publication No. 99/18440 Pamphlet).

The basis of Structured Based Drug Design (SBDD) begins with the determination of the binding site of a drug to a target protein.

In reality, however, a technology has yet to be established for identifying a site where a drug can bind to a certain protein, and researchers still search for locations likely to serve as binding sites through a trial and error process.

The amount of protein three-dimensional structure information contained in the PDB is increasing each year, and it currently contains more than 29,000 entries. However, the sites where drugs bind have not been identified for the majority of the proteins. Thus, it has been difficult to search for drug binding sites of proteins from protein three-dimensional structure information databases such as the PDB.

Even when a drug designed according to SBDD binds to a certain protein, there is a possibility of the drug causing adverse side effects as a result of binding with another protein. In the conventional technique, however, it is unknown as to whether a similar binding site (surface morphology) is present in another protein, and proteins having the potential for causing adverse side effects cannot be predicted. Thus, the potential for causing adverse side effects must be determined through experimentation and research, thereby resulting in the problem of prolonging drug design.

According to the conventional technique of International Publication No. 99/18440, since the three-dimensional structure of a protein is predicted based on its amino acid sequence, it is not possible to predict a drug binding site from the three-dimensional morphology of the protein or predict those proteins having the potential for causing adverse side effects from a drug binding site, disadvantageously.

### SUMMARY OF THE INVENTION

It is an object of the present invention to at least solve the problems in the conventional technology.

A search device for searching a specific surface site of protein according to an aspect of the present invention includes: a database that stores morphology data of a plurality of first surface sites of a first protein and a plurality of second surface sites of a second protein; a specifying unit that specifies one of the first surface sites as a drug binding site; a searching unit that searches one of the second surface sites, which is any one of a surface site identical to the drug binding site and a surface site similar to the drug binding site, as a probable drug binding site based on the morphology data stored in the database; and an output unit that outputs the probable drug binding site.

A search method according to another aspect of the present invention is a method of searching a specific surface site of protein using a database that stores morphology data of a plurality of first surface sites of a first protein and a plurality of second surface sites of a second protein. The search method includes: specifying one of the first surface sites as a drug binding site; searching one of the second surface sites, which is any one of a surface site identical to the drug binding site and a surface site similar to the drug binding site, as a probable drug binding site based on the morphology data stored in the database; and outputting the probable drug binding site.

A computer-readable recording medium according to still another aspect of the present invention stores therein a computer program for searching a specific surface site of protein using a database that stores morphology data of a plurality of first surface sites of a first protein and a plurality of second surface sites of a second protein. The computer program causes a computer to execute: specifying one of the first surface sites as a drug binding site; searching one of the second surface sites, which is any one of a surface site identical to the drug binding site and a surface site similar to the drug binding site, as a probable drug binding site based on the morphology data stored in the database; and outputting the probable drug binding site.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is an explanatory diagram of an outline of a protein surface morphology search according to the present invention;

FIG. 2 is a block diagram of the hardware configuration of a search device according to the present invention;

FIG. 3 is an explanatory diagram of a protein information database (DB);

FIG. 4 is a block diagram of the search device;

FIG. 5 is an explanatory diagram of a surface morphology of protein;

FIG. 6 is an explanatory diagram of a profile database (DB);

FIG. 7 is an explanatory diagram of query morphology data set by a setting unit;

FIG. 8 is an explanatory diagram of a group of amino acid residues within a segment that composes query morphology data, and a group of amino acid residues of a segment that composes morphology data of another protein;

FIG. 9 is an explanatory diagram of a list of distances between amino acid residues in segments;

FIG. 10 is an explanatory diagram of a group of segments identified by a segment identifying unit;

FIG. 11 is a flowchart of a surface morphology search process performed by the search device;

FIG. 12 is a flowchart of a profile DB construction process shown in FIG. 11;

FIG. 13 is a flowchart of a query setting process shown in FIG. 11;

FIG. 14 is a flowchart of a search process shown in FIG. 11; and

FIG. 15 is a flowchart of a segment specification process shown in FIG. 14.

### DETAILED DESCRIPTION OF THE PREFERRED EMBODIMENTS

Exemplary embodiments of the present invention will be explained below in detail with reference to the accompanying drawings.

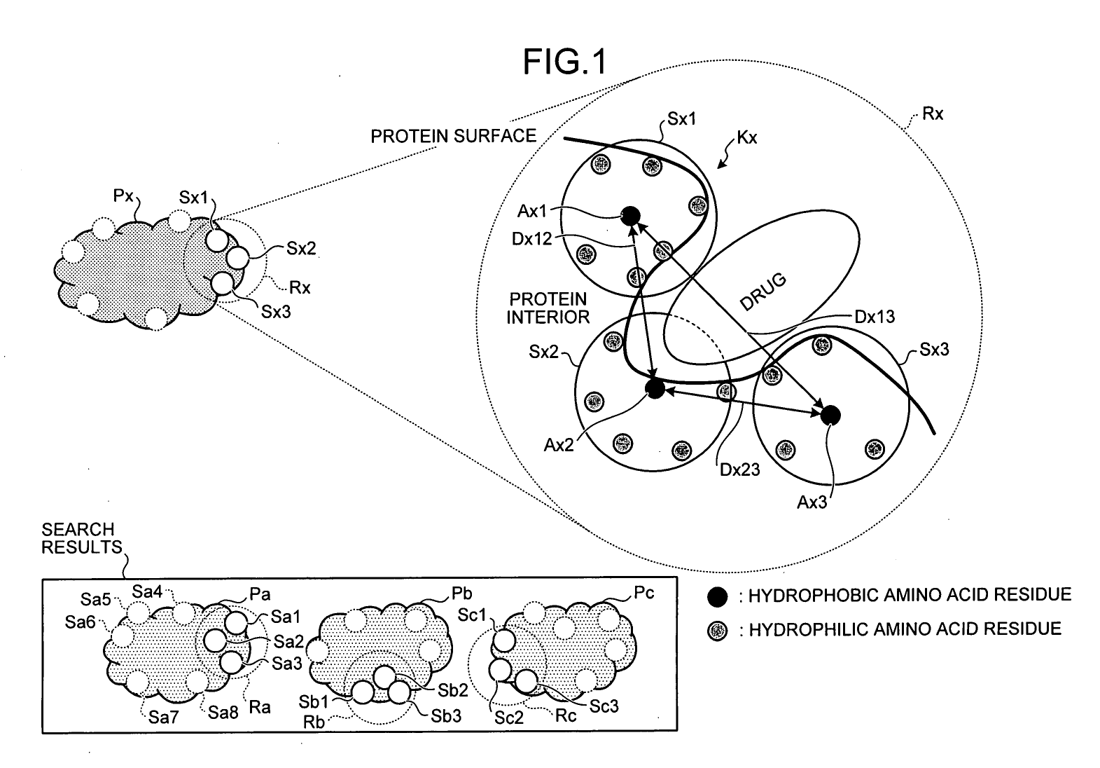

FIG. 1 is an explanatory diagram of the outline of a protein surface morphology search according to the present invention. As shown in FIG. 1, a target protein Px has a surface site where a drug binds (drug binding site Rx). The drug binding site Rx can have a surface morphology that has been verified to be bound by a drug or can have a surface morphology that has a possibility of being bound by a drug.

The drug binding site Rx of the target protein Px has segments Sx1 to Sx3 that determine the surface morphology of the drug binding site Rx. Each segment Sx1 to Sx3 is a three-dimensional sphere having the amino acid residues Ax1 to Ax3 on the drug binding site Rx at its geometrical center. The amino acid residues Ax1 to Ax3 are preferably hydrophobic amino acid residues since they are involved in drug binding. The segments Sx1 to Sx3 contains both amino acid residues located at the drug binding site Rx on the surface of the protein and amino acid residues located inside the protein.

The surface morphology of the drug binding site Rx, which is specified by a profile (attribute information) of amino acid residues within the segments Sx1 to Sx3 and distances Dx12, Dx13, and Dx23 between each hydrophobic amino acid residue Ax1 to Ax3 at the geometrical center of each segment Sx1 to Sx3, is used as a query for a search process (query morphology data Kx). As a result of the search process using the query morphology data Kx, a surface site Ra of a protein Pa, a surface site Rb of a protein Pb, and a surface site Rc of a protein Pc, for example, are identified as surface sites having identical or similar surface morphologies to that of the drug binding site Rx.

More specifically, a combination of segments Sal to Sa3 forming the surface morphology of the protein Pa is identical or similar to the segments Sx1 to Sx3 forming the drug binding site Rx of the target protein Px, while a combination of segments that contain other segments Sa4 to Sa8 is not similar to the segments Sx1 to Sx3 forming the drug binding site Rx of the target protein Px.

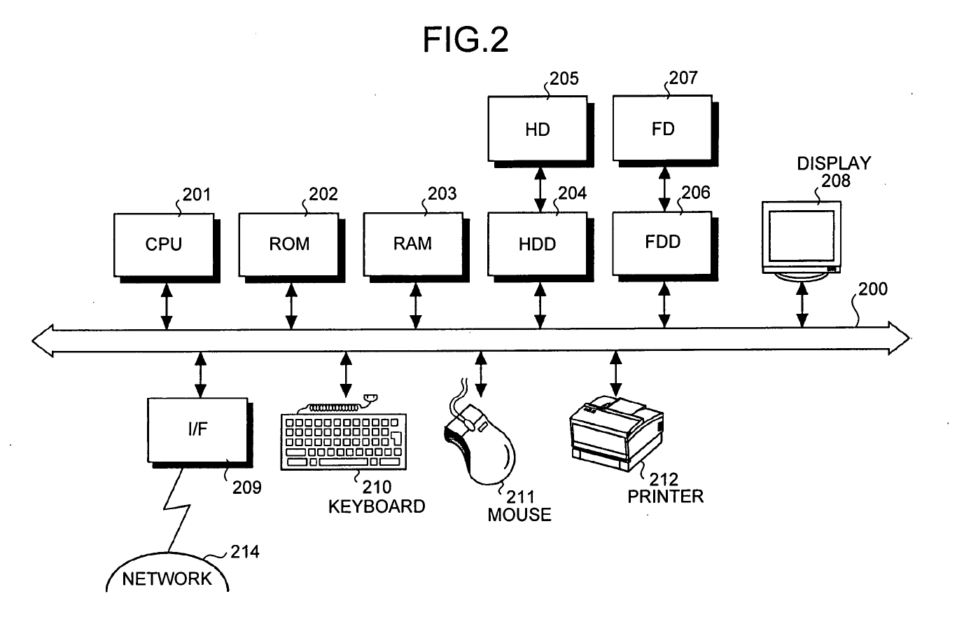

FIG. 2 is a block diagram of the hardware configuration of the the search device according to the embodiment.

In FIG. 2, the search device includes a central processing unit (CPU) 201, a read only memory (ROM) 202, a random access memory (RAM) 203, a hard disk drive (HDD) 204, a hard disk (HD) 205, a flexible disk drive (FDD) 206, a flexible disk (FD) 207 as an example of a removable recording medium, a display 208, an interface (I/F) 209, a keyboard 210, a mouse 211, and a printer 212. Each constituent element is respectively connected by a bus 200.

The CPU 201 controls the entire search device. The ROM 202 stores a boot program and other programs. The RAM 203 is used as a work area of the CPU 201. The HDD 204 controls reading and writing of data to and from the HD 205 as controlled by the CPU 201. The HD 205 stores data written under the control of the HDD 204.

The FDD 206 controls reading and writing of data to the FD 207 as controlled by the CPU 201. The FD 207 stores data written under the control of the FDD 206 or reads data stored on the FD 207 to the search device.

A CD-ROM (CD-R, CD-RW), magneto-optical (MO), a digital versatile disk (DVD), or a memory card and the like can be used as a removable storage medium in addition to the FD 207. The display 208 displays a cursor, icons or tool boxes, as well as text, images, function information and other data. A cathode ray tube (CRT), a thin film transistor (TFT) liquid crystal display, or plasma display, for example, can be used for the display 208.

The I/F 209 is connected to a network 214 such as the Internet through a communication line, and is connected to other devises via the network 214. The I/F 209 controls an internal interface with the network 214, and controls input and output of data from an external device. A modem or a local area network (LAN) adapter, for example, can be used for the I/F 209.

The keyboard 210 includes keys for inputting characters, numbers, various instructions and the like, and performs input of data. The keyboard 210 can be in the form of a touch panel-type input pad, a numerical keypad, and the like. The mouse 211 is used to move and select the range of the cursor or move and change the size of a window. It can also be a tracking ball or joystick or the like, provided it has the same function as a pointing device.

The printer 212 prints out image data and text data. A laser printer or ink jet printer can be used for the printer 212.

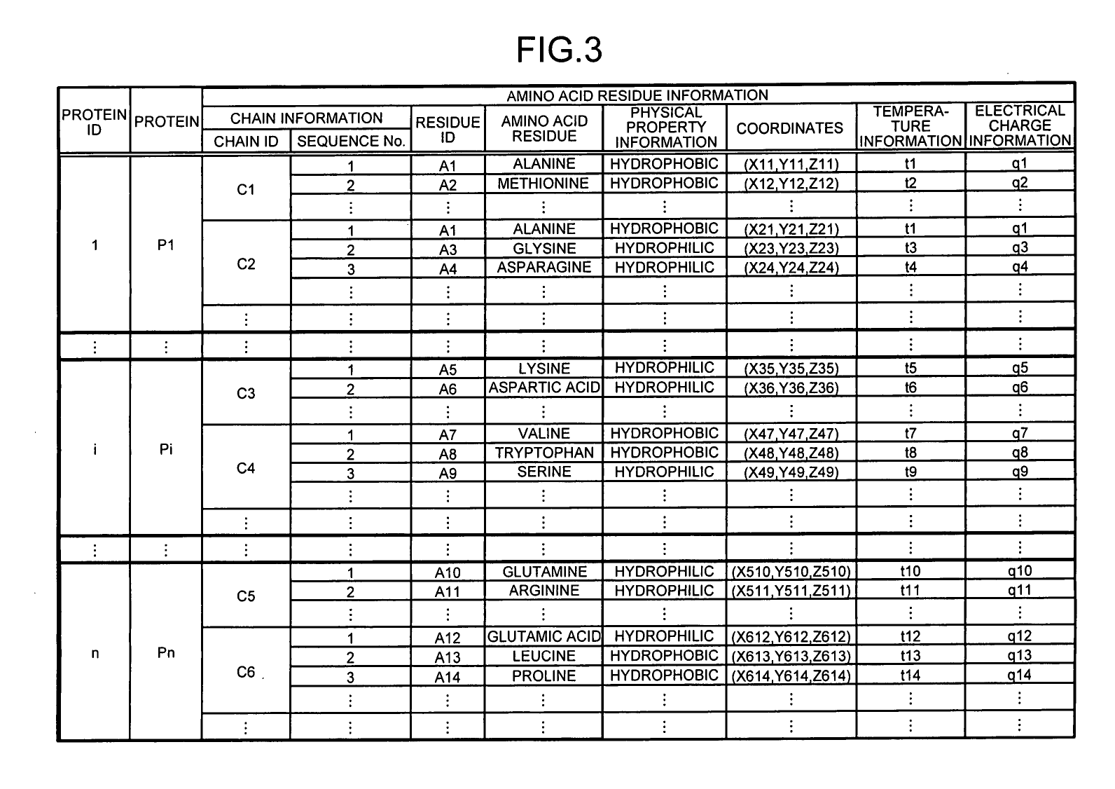

FIG. 3 is an explanatory diagram of the protein information DB of according to the embodiment. As shown in FIG. 3, information of each protein is stored in a protein information DB 300. More specifically, proteins are identified by protein IDs. For example, the protein of ID=i (i=1 to n) is Pi.

Information on amino acid residues that compose a protein three-dimensional structure (amino acid residue information) is stored for each protein in the protein information DB 300. Amino acid residue information includes chain information, a residue ID, amino acid residue, physical property information, coordinates, temperature information, and electrical charge information.

The chain information refers to identification information that relates to the amino acid chains that compose a protein, and includes a chain ID and a sequence number. Amino acid chains in which amino acid residues are present can be identified by the chain ID, while actual sequence locations on an amino acid chain identified by amino acid residues according to its chain ID can be identified by a sequence number.

The residue ID and amino acid residues are identification information that relates to 20 types of amino acid residues, and for example, ID=A1 is alanine and ID=A2 is methionine. Physical property information indicates whether an amino acid residue is hydrophobic or hydrophilic. Coordinates represent a location in a three-dimensional space within a protein. Temperature information includes the mean temperature and temperature standard deviation of an amino acid residue, and represents fluctuations in the temperature of an amino acid residue. Electrical charge information represents an amount of electrical charge possessed by an amino acid residue.

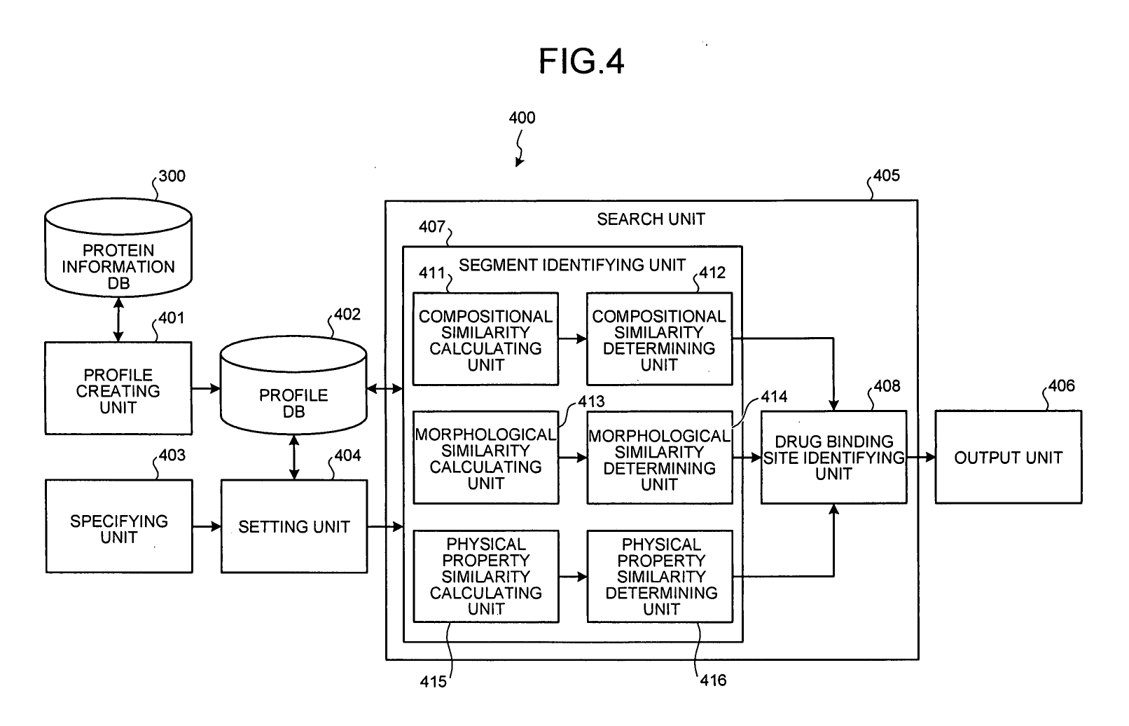

FIG. 4 is a block diagram of the search device. In FIG. 4, a search device 400 is composed of the protein information DB 300 shown in FIG. 3, a profile creating unit 401, a profile database (DB) 402, a specifying unit 403, a setting unit 404, a search unit 405, and an output unit 406.

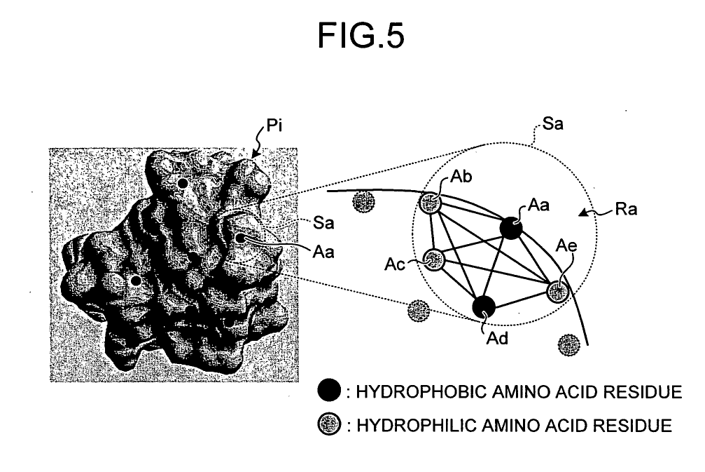

To begin with, the profile creating unit 401 extracts protein information from the protein information DB 300. More specifically, the profile creating unit 401 selects protein information stored in the protein information DB 300 in the order of the protein ID, and creates a profile for each protein. Although a specific process for creating profiles will be explained later, it is explained briefly with reference to FIG. 5. FIG. 5 is an explanatory diagram of the surface morphology of protein Pi.

When focusing on a hydrophobic amino acid residue Aa present on a protein surface at an arbitrary surface site Ra of the protein Pi shown in FIG. 5, the profile creating unit 401 creates a profile relating to a segment Sa, which is in the form of a sphere of predetermined radius having the hydrophobic amino acid residue Aa at its geometrical center, by using amino acid residues Aa to Ae (five are shown as an example in FIG. 5) present in the segment Sa.

Examples of information contained in the profile include incidence information for each amino acid residue (each residue ID) present in the segment Sa among the 20 types of amino acid residues, distances between the amino acid residues Aa to Ae, chain locations, segment center coordinates, segment's internal electrical charge information and segment's internal temperature information.

The incidence information refers to information representing the composition of the segment Sa, and more specifically, includes count values indicating an incidence frequency of amino acid residues present within the segment Sa which are counted by the profile creating unit 401. For example, if the amino acid residues Aa and Ad are assumed to be the hydrophobic amino acid residue valine (residue ID=A7), the count for the residue ID=A7 is “2”.

Distances between residues are information that represents the morphology of the group of the amino acid residues Aa to Ae in the segment Sa (in other words, represents an arrangement of the amino acid residues Aa to Ae in the segment Sa). This information is calculated from coordinates extracted by the profile creating unit 401 extracting the coordinates of the amino acid residues Aa to Ae from the protein information DB 300.

More specifically, the distances between amino acid residues for the amino acid residues Aa to Ae consists of the distance between the amino acid residues Aa and Ab, the distance between the amino acid residues Aa and Ac, the distance between the amino acid residues Aa and Ad, the distance between the amino acid residues Aa and Ae, the distance between the amino acid residues Ab and Ac, the distance between the amino acid residues Ab and Ad, the distance between the amino acid residues Ab and Ae, the distance between the amino acid residues Ac and Ad, the distance between the amino acid residues Ac and Ae, and the distance between the amino acid residues Ad and Ae.

The chain location indicates locations of the amino acid residues Aa to Ae in the segment Sa, and is extracted by the profile creating unit 401 from the protein information DB 300. More specifically, the chain information shown in FIG. 3 (combinations of chain IDs and sequence numbers) is extracted from the protein information DB 300. Accordingly, correlations can be made with actual three-dimensional locations specified in the protein information DB 300.

Segment center coordinate information refers to the coordinates of the amino residue Aa serving as the geometrical center of the segment Sa, and is extracted by the profile creating unit 401 from the protein information DB 300. The segment's internal electrical charge information refers to physical property information that represents the amount of electrical charge of the segment Sa, and includes, for example, the mean value and standard deviation of the electrical charge possessed by the atoms of each amino acid residue Aa to Ae present in the segment Sa. More specifically, the segment's internal electrical charge information is calculated by the profile creating unit 401 from the value of each electrical charge extracted by extracting the electrical charges of the atoms of each amino acid residue Aa to Ae from the protein information DB 300 by the profile creating unit 401.

The segment's internal temperature information refers to physical property information that represents fluctuations in the temperature inside the segment Sa, and includes, for example, the mean value and standard deviation of the temperature of the atoms of each amino acid residue Aa to Ae present in the segment Sa. More specifically, the segment's internal temperature information is calculated by the profile creating unit 401 from the value of each temperature extracted by extracting the temperature of the atoms of each amino acid residue Aa to Ae based on the protein information DB 300 by the profile creating unit 401.

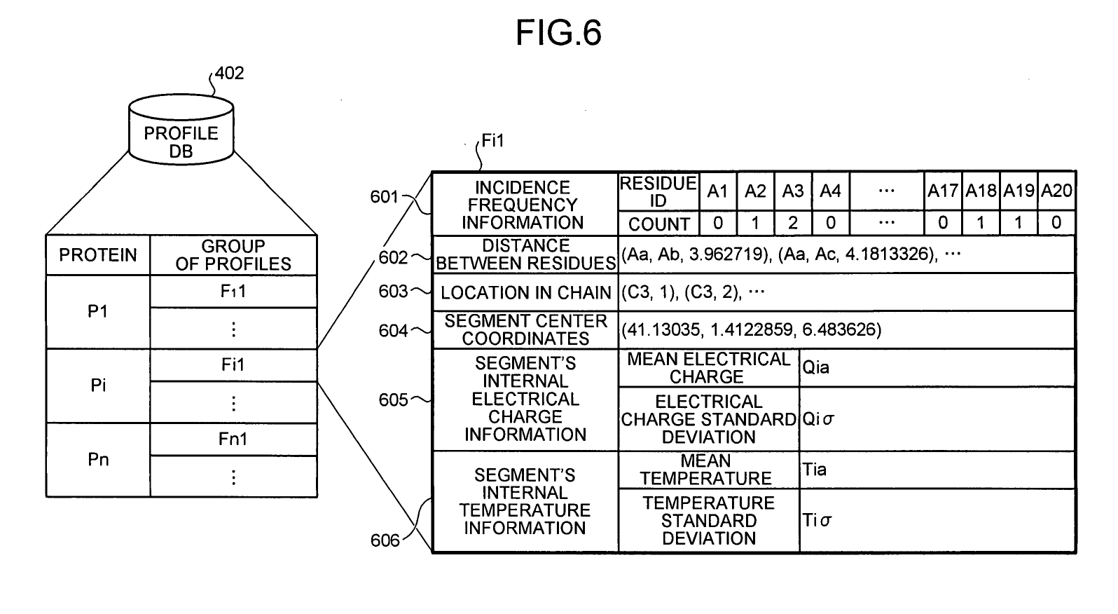

In FIG. 4, the profile DB 402 stores the profile described above for each protein. FIG. 6 is an explanatory diagram of the profile DB 402. In FIG. 6, a group of profiles composed of the profiles of each segment is stored for each protein (P1 to Pn). The explanation in FIG. 6 uses profile Fi1 of the protein Pi. The profile Fi1 is composed of the incidence information 601, a distance between residues 602, a location within a chain 603, segment center coordinates 604, segment's internal electrical charge information 605, and segment's internal temperature information 606.

Count values indicating incidence frequencies are stored for each residue ID in the incidence information 601, and more specifically, the incidence frequency is counted for each residue ID shown in FIG. 3 in the profile creating unit 401. Distances between residues such as (Aa, Ab, 3.962719) calculated by the profile creating unit 401 are stored for the distance between residues 602. (Aa, Ab, 3.962719) indicates that the distance between the amino acid residues Aa and Ab is 3.962719 Å.

The chain location information (combination of a chain ID and a sequence number) such as (C3, 1) of each amino acid residue is stored for the location within the chain 603. (C3, 1) indicates that the chain ID is “C3” and that the sequence number is “1”. The three-dimensional coordinates of the amino acid residue at the geometrical center of a segment is stored for the segment center coordinates 604. In this embodiment, although the chain IDs are shown as C1, C2, C3, and so forth for the sake of convenience, they are actually IDs registered with a single letter of the alphabet (for example, A).

The mean electrical charge Qia and its standard deviation Qiσ of the amino acid residues within a segment are stored for the segment's internal electrical charge information 605. Similarly, the mean temperature Tia and its standard deviation Tiσ of the amino acid residues within a segment are stored for the segment's internal temperature information 606.

In FIG. 4, the specifying unit 403 accepts a specification of the drug binding site Rx of the target protein Px that is bound by a drug. More specifically, the specification of the drug binding site Rx is accepted by, for example, user's operation of the keyboard 210 and the mouse 211 shown in FIG. 2.

The setting unit 404 sets morphology data having as its vertices segments Sx1 to Sx3 composed of amino acid residues located at the drug binding site Rx and amino acid residues around a query. More specifically, if the drug binding site Rx of the target protein Px has been specified by the specifying unit 403, for example, the segments Sx1 to Sx3, which has for its segment center coordinates the coordinates of the amino acid residues Ax1 to Ax3 located at the drug binding site Rx, are extracted from the group of profiles of the target protein Px. The morphology data used for the query (query morphology data) has the extracted segments Sx1 to Sx3 as its vertices. The setting unit 404 then calculates the distances Dx12, Dx13, and DX23 between the segments Sx1 to Sx3 serving as the vertices of the query morphology data.

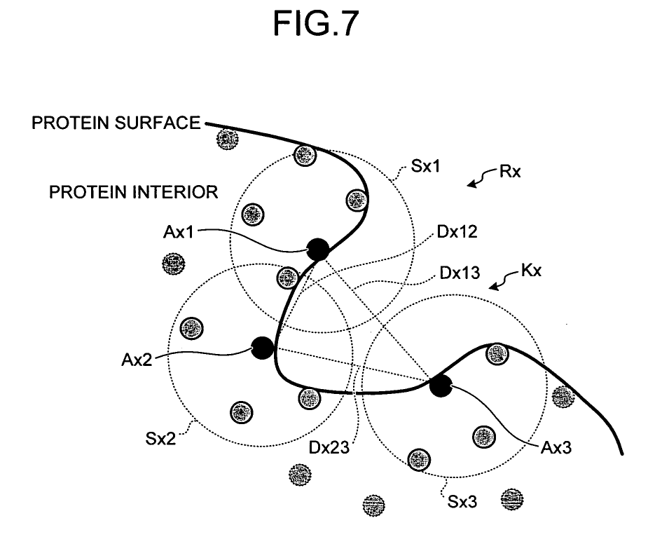

FIG. 7 is an explanatory diagram of the query morphology data Kx set by the setting unit 404. In FIG. 7, the segments Sx1 to Sx3 constitute a group of segments that compose the drug binding site Rx. The query morphology data Kx includes morphology data having as its vertices segments Sx1 to Sx3, and has the profiles of the segments Sx1 to Sx3. The query morphology data Kx also has the distances Dx12, Dx13, and Dx23 between the amino acid residues Ax1 to Ax3 at the geometrical center of each segment Sx1 to Sx3 that are calculated as the distances between each segment Sx1 to Sx3.

In FIG. 4, the search unit 405 searches for a surface site that is identical or similar to the drug binding site specified by the specifying unit 403 among the surface morphologies of proteins other than the target protein Px, based on the query morphology data Kx set by the setting unit 404, and morphology data having as its vertices segments composed of amino acid residues present on the surface of other proteins and amino acids in their vicinity.

More specifically, the search unit 405 is composed of a segment identifying unit 407 and a drug binding site identifying unit 408. The segment identifying unit 407 identifies a segment identical or similar to a segment that composes the vertices of the query morphology data Kx from among segments that compose the vertices of morphology data of another protein. More specifically, the segment identifying unit 407 is composed of a compositional similarity calculating unit 411, a compositional similarity determining unit 412, a morphological similarity calculating unit 413, a morphological similarity determining unit 414, a physical property similarity calculating unit 415, and a physical properly similarity determining unit 416.

First, the compositional similarity calculating unit 411 calculates the compositional similarity of those segments that compose the vertices of the morphology data of another protein relative to a segment that composes the vertices of query morphology data, based on the incidence frequency of each type of amino acid residue within the segment that composes the vertices of the query morphology data Kx and the incidence frequency of each type of amino acid residue within the segments that compose the vertices of morphology data of another protein.

A vector Vx serving as incidence information in the profile of an arbitrary segment Sxj (j=1 to 3) among the segments Sx1 to Sx3 that compose the query morphology data Kx is defined as Vx=(Vx1, . . . , Vxk, . . . , Vx20), while a vector Vy serving as incidence information in the profile of an arbitrary segment Syj (j=1 to 3) among segments Sy1 to Sy3 that compose the morphology data of other proteins is defined as Vy=(Vy1, . . . , Vyk, . . . , Vy20).

Each value in the vectors Vx and Vy (Vx1 to Vx20, Vy1 to Vy20) represents the incidence frequency of an amino acid residue, and the number indicated by the value corresponds to the residue ID. Namely, Vx1 and Vy1 respectively indicate the incidence frequency of the amino acid residue (alanine) of residue ID=A1. A compositional similarity Sa is calculated according to the following equation (1) from these vectors Vx and Vy.

$$Sa = 1 - \frac{{\sum }_{i = 1}^{20} {W}_{i} \times \vert {V}_{xi} - {V}_{yi} \vert}{{\sum }_{i = 1}^{20} {W}_{i} \times Max ( {V}_{xi ,} {V}_{yi} )} \qquad ( 1 )$$

The compositional similarity determining unit 412 determines whether the compositional similarity Sa calculated by the compositional similarity calculating unit 411 is equal to or greater than a predetermined compositional similarity Sat. If it is equal to or greater than the predetermined compositional similarity Sat, then the segment identifying unit 407 can identify a segment Sy that composes morphology data of another protein is identical or similar to the segment Sx that composes the query morphology data Kx with respect to the internal composition of the segment Sy.

The morphological similarity calculating unit 413 calculates a morphological similarity Sd of the segment Sy that composes the vertices of morphology data of another protein relative to the segments Sx1 to Sx3 that compose the vertices of the query morphology data Kx based on the distances between amino acid residues in the segments Sx1 to Sx3 that compose the vertices of the query morphology data Kx and the distances between amino acid residues in the segment Sy that composes the vertices of morphology data of another protein.

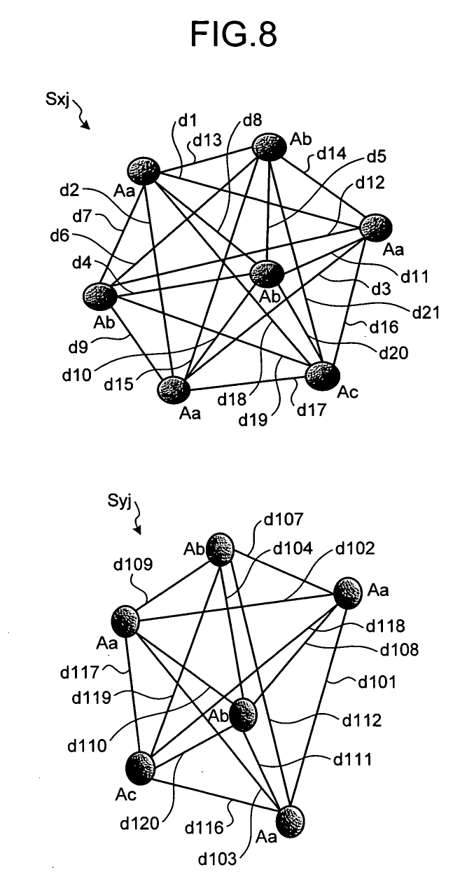

The following explains the calculation of the morphological similarity Sd with reference to the drawings. FIG. 8 is an explanatory diagram of a group of amino acid residues in an arbitrary segment Sxj (j=1 to 3) among the segments Sx1 to Sx3 that compose the query morphology data Kx, and a group of amino acid residues of an arbitrary segment Syj (j=1 to 3) among the segments Sy1 to Sy3 that compose the morphology data of another protein.

In FIG. 8, the segment Sxj is composed of the amino acid residues Aa, Ab, and Ac. In the segment Sxj, d1 to d21 are lines that connect each amino acid residue, and represent the distances between residues for each of the amino acid residues. The segment Syj is also composed of the amino acid residues Aa, Ab, and Ac. In the segment Syj, d101 to d104, d107 to d112, and d116 to d120 are lines that connect each amino acid residue, and represent the distances between residues for each of the amino acid residues.

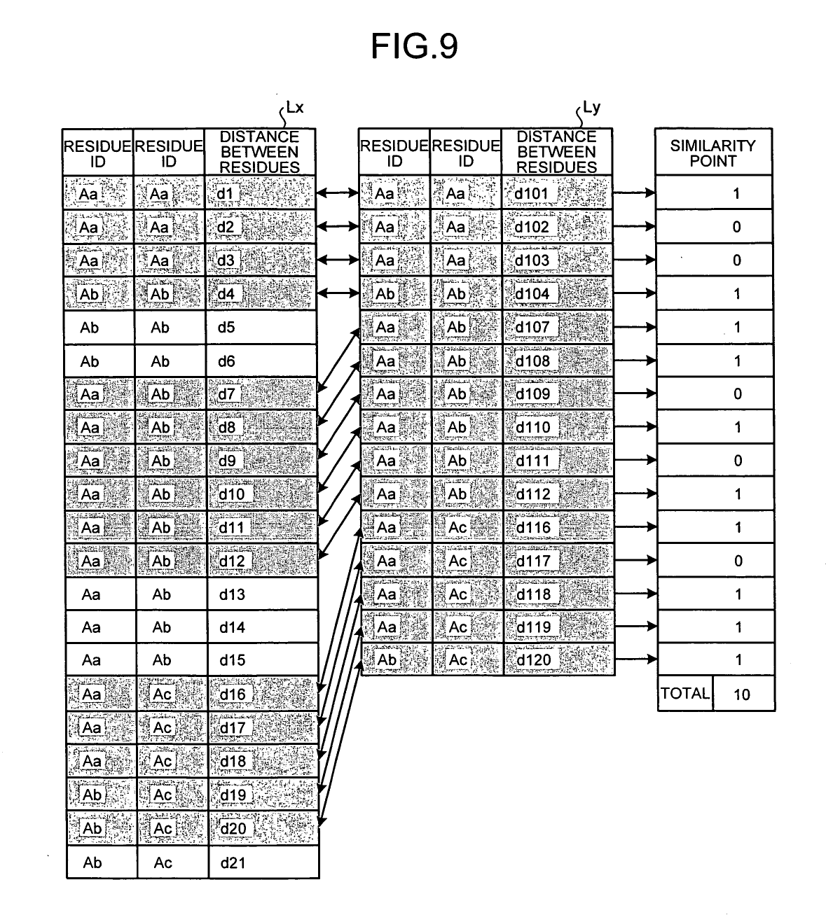

FIG. 9 is an explanatory diagram of an inter-residue distance list Ly for the segment Sxj, and the inter-residue distance list Ly for the segment Sy1. In FIG. 9, combinations of amino acid residues (assigned with residue IDs in FIG. 9) having the distances between residues d1 to d21 are sorted in ascending order of the distances between residues d1 to d21 for each of those combinations on an inter-residue distance list Lx. Similarly, combinations of amino acid residues (assigned with the residue IDs in FIG. 9) having distances between residues d101 to d104, d107 to d112, and d116 to d120 are also sorted in ascending order of the distances between residues d101 to d104, d107 to d112, and d116 to d120 for each of those combinations on the inter-residue distance list Ly.

Both the lists Lx and Ly are then compared, and only those combinations of amino acid residues that are common to both the lists Lx and Ly are saved, while those combinations of amino acid residues present on only one of the lists are deleted and not targeted for comparison. In FIG. 9, the combination of the residue IDs representing the distances between residues d5 and d6 (Ab, Ab), the combination of the residue IDs representing the distances between residues d13 to d15 (Aa, Ab), and the combination of the residue IDs representing the distance between residues d21 (Ab, Ac) are deleted from the inter-residue distance list Lx.

As indicated by the arrows between the lists Lx and Ly, comparisons are made in order starting from the first distance between residues. More specifically, a comparison is made between the distance between residues d1 of the inter-residue distance list Lx and the distance between residues d101 of the inter-residue distance list Ly. If the difference between the distance between residues d1 and the distance between residues d101 of the inter-residue distance list Ly is within a predetermined range, then the combination of amino acid residues having the distance between residues d1 of the segment Sxj (Aa, Aa), and the combination of amino acid residues having the distance between residues d101 of the segment Syj (Aa, Aa) are determined to have identical or similar structures, and the similarity score is set to “1”.

If the difference between a distance between residues d2 and the distance between residues d102 of the inter-residue distance list Ly is not within a predetermined range as in a comparison between the distance between residues d2 of the inter-residue distance list Lx and the distance between residues d102 of the inter-residue distance list Ly, then the combination of amino acid residues having the distance between residues d2 of the segment Sx (Aa, Aa), and the combination of amino acid residues having distance between residues d102 of the segment Sy (Aa, Aa) are determined to be dissimilar structures, and the similarity score is set to “0”. Following completion of comparison, the similarity scores are added to calculate a total similarity score (“10” in FIG. 9).

When the total similarity score has been calculated, the morphological similarity Sd between the segment Sxj that composes the query morphology data Kx and the segment Syj that composes morphology data of another protein is calculated according to equation (2) below.

$$Sd = \frac{{D}_{w} \times 2}{{D}_{x} + {D}_{y}} \qquad ( 2 )$$

In equation (2), Dw represents the total similarity score, Dx represents the total number of combinations of the residue IDs of the inter-residue distance list Lx (“21” on the inter-residue distance list Lx), and Dy represents the total number of combinations of the residue IDs of the inter-residue distance list Ly (“15” on the inter-residue distance list Lx).

Since Dx and Dy are used in equation (2), Dw becomes the value of Dx or Dy, whichever is smaller, even at maximum. In this manner, as a result of calculating the morphological similarity Sd by sorting distances between residues and deleting those combinations of amino acid residues that are not in common, the number of calculations can be reduced and a calculation speed can be improved as compared with the calculation using freely determined coordinate locations in a three-dimensional space. The accuracy of the morphological similarity Sd can be improved by comparing combinations having coinciding types of amino acid residues.

Since distance between residues is used in the calculation of the morphological similarity Sd, it is not necessary to compare the comparison objects of the segments Sxj and Syj by moving or rotating in the three-dimensional space, thereby making it possible to reduce the number of calculations. Thus, a search speed can be improved.

In FIG. 4, the morphological similarity determining unit 414 determines whether the morphological similarity Sd calculated by the morphological similarity calculating unit 413 is equal to or greater than a predetermined morphological similarity Sdt. If it is equal to or greater than the predetermined morphological similarity Std, then the segment determining unit 407 can identify the segment Syj that composes morphology data of another protein is a segment that is identical or similar to the segment Sxj that composes the query morphology data with respect to the morphology of the group of amino acid residues within the segment Sy1.

The physical property similarity calculating unit 415 calculates a physical property similarity Sp of the segment Sy that composes the vertices of morphology data of another protein relative to a segment that composes the vertices of the query morphology data, based on physical property information of amino acid residues in the segment Sxj that composes the vertices of the query morphology data Kx and physical property information of amino acid residues in the segment Syj that composes the vertices of morphology data of another protein.

Physical property information refers to information that represents the physicochemical characteristics of amino acid residues, and includes the segment's internal electrical charge information 605 and the segment's internal temperature information 606 shown in FIG. 6. The physical property similarity Sp is calculated using physical property vectors obtained from physical property information. For example, if the physical property vector of the segment Sx is defined as PCx, then PCx=(Qxa, Qxσ, Txa, Txσ). Qxa represents the mean electrical charge of the segment's internal electrical charge information in the profile of the segment Sx, Qxσ represents its standard deviation, Txa represents the mean temperature of the segment's internal temperature information in the profile of the segment Sx, and Txσ represents its standard deviation.

Similarly, if the physical property vector of the segment Sy is defined as PCy, then PCy=(Qya, Qyσ, Tya, Tyσ). Qya represents the mean electrical charge of the segment's internal electrical charge information in the profile of the segment Sy, Qyσ represents its standard deviation, Tya represents the mean temperature of the segment's internal temperature information in the profile of the segment Sy, and Tyσ represents its standard deviation. The physical property similarity calculating unit 415 calculates the physical property similarity Sp according to equation (3) below.

$$Sp = cos θ = \frac{{PC}_{x} \cdot {PC}_{y}}{\vert {PC}_{x} \vert \cdot \vert {PC}_{y} \vert} \qquad ( 3 )$$

The physical property similarity determining unit 416 determines whether the physical property similarity Sp calculated by the physical property similarity calculating unit 415 is equal to or greater than a predetermined physical property similarity Spt. If it is equal to or greater than the predetermined physical property similarity Spt, then the segment Syj that composes morphology data of another protein can be determined to be identical or similar to the segment Sxj that composes the query morphology data with respect to the physical properties of a group of amino acid residues within the segment Sy. Namely, since drugs are considered to bind easily in the same manner as the drug binding site if physical properties are similar, whether the surface morphology is identical or similar to the drug binding site can be determined by considering physical properties.

When the segment Syj has been determined to be identical or similar to the segment Sxj by all determining units with respect to the compositional similarity determining unit 412, the morphological similarity determining unit 414, and the physical property similarity determining unit 416, the segment identifying unit 407 can identify the segment Syj is identical or similar to the segment Sxj. When the segment Syj has been determined to be identical or similar to the segment Sxj by at least any one (or two) of the compositional similarity determining unit 412, the morphological similarity determining unit 414, and the physical property similarity determining unit 416, the segment identifying unit 407 can identify whether the segment Syj is identical or similar to the segment Sxj.

The drug binding site identifying unit 408 identifies morphology data that is identical or similar to the query morphology data Kx, based on the distance between segments that compose the vertices of the query morphology data Kx and the distance between those segments of the morphology data of other proteins that are identified by the segment identifying unit 407. The distance between segments can be, for example, the distance between amino acid residues located at the geometrical center of a segment.

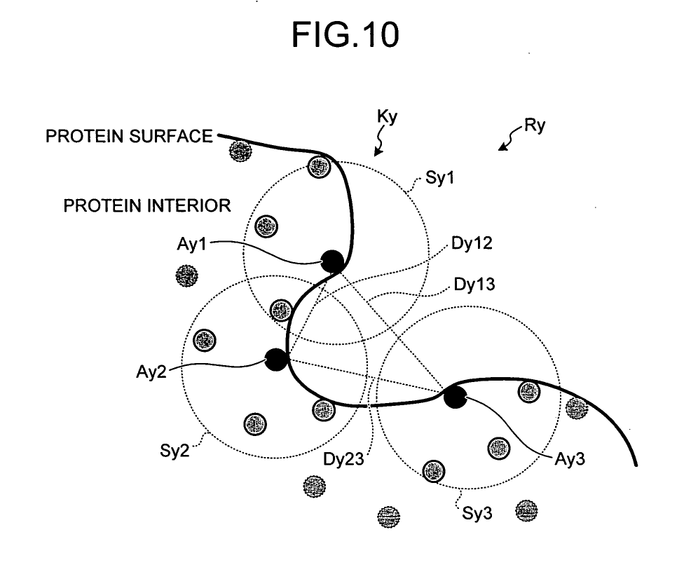

A group of segments identified by the segment identifying unit 407 is explained with reference to the drawings. FIG. 10 is an explanatory diagram of a group of segments identified by the segment identifying unit 407. In FIG. 10, the amino acid residues Ay1 to Ay3 are present on the surface of another protein (surface site Ry). The segment Sy1 is a segment having as its geometrical center the amino acid residue Ay1, the segment Sy2 is a segment having as its geometrical center the amino acid residue Ay2, and the segment Sy3 is a segment having as its geometrical center the amino acid residue Ay3. Morphology data having as its vertices segment Sy1 to Sy3 is the morphology data Ky of the other protein.

The segment Sy1 is assumed to be a segment determined as being similar to the segment Sx1 that composes the drug binding site Rx of the target protein Px shown in FIG. 7. The segment Sy2 is assumed to be a segment determined as being similar to the segment Sx2 that composes the drug binding site Rx of the target protein Px shown in FIG. 7. The segment Sy3 is assumed to be a segment determined to be similar to the segment Sx3 that composes the drug binding site Rx of the target protein Px shown in FIG. 7.

In this case, the drug binding site identifying unit 408 calculates the difference between the distance between the segments Sx1 and Sx2 shown in FIG. 7 and the distance between the segments Sy1 and Sy2 shown in FIG. 10. It also calculates the difference between the distance between the segments Sx1 and Sx3 shown in FIG. 7 and the distance between the segments Sy1 and Sy3 shown in FIG. 10. Furthermore, it calculates the difference between the distance between the segments Sx2 and Sx3 shown in FIG. 7 and the distance between the segments Sy2 and Sy3 shown in FIG. 10.

If the distance between amino acid residues located at the geometrical centers of segments is defined as the distance between the segments, for example, then the difference is calculated between the distance between amino acid residues Dx12 between the amino acid residues Ax1 and Ax2 shown in FIG. 7 and distance between amino acid residues Dy12 between the amino acid residues Ay1 and Ay2 shown in FIG. 10. The difference is also calculated between the distance between amino acid residues Dx13 between the amino acid residues Ax1 and Ax3 shown in FIG. 7 and distance between amino acid residues Dy13 between the amino acid residues Ay1 and Ay3 shown in FIG. 10. Furthermore, the difference is calculated between the distance between amino acid residues Dx23 between the amino acid residues Ax2 and Ax3 shown in FIG. 7 and distance between amino acid residues Dy23 between the amino acid residues Ay2 and Ay3 shown in FIG. 10.

If these differences are within a predetermined allowance, then the morphology data Ky of the other protein Py composed of the segments Sy1 to Sy3 is determined as being morphology data that is identical or similar to the query morphology data Kx of the target protein Px composed of the segments Sx1 to Sx3.

In FIG. 4, the output unit 406 outputs the result of searching by the search unit 405, namely morphology data identified by the drug binding site identifying unit 408 or morphology site Ry of other protein Py that composes the morphology data. More specifically, the output unit 406 writes and stores morphology data or a morphology site to a recording medium such as the ROM 202, the RAM 203, or the HD 205 shown in FIG. 2, displays it on the display 208, or prints it out by the printer 212.

The functions of the protein information DB 300 and the profile DB 402 can be specifically realized by, for example, a recording medium such as the ROM 202, the RAM 203, or the HD 205 shown in FIG. 2. The functions of the specifying unit 403, the setting unit 404, the search unit 405, and the output unit 406 can be specifically realized by, for example, having a program recorded on a recording medium such as the ROM 202, the RAM 203, or the HD 205 shown in FIG. 2 run by the CPU 201 or the I/F 209.

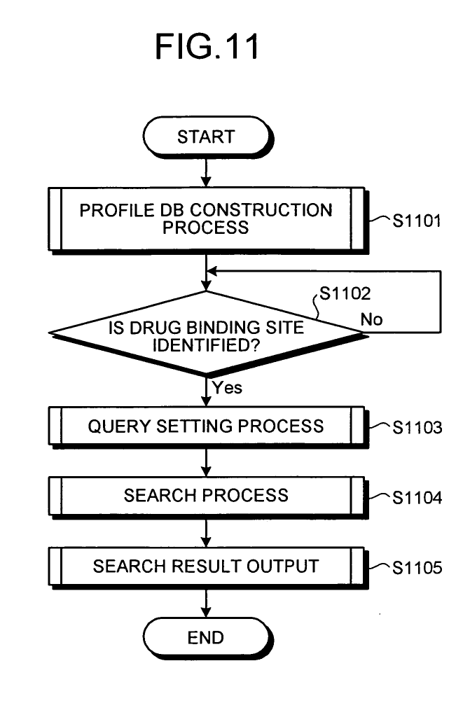

The following explains a search process for a surface morphology by the search device 400. FIG. 11 is a flowchart of a surface morphology search process performed by the search device 400. In FIG. 11, a construction process of a profile DB is first carried out by the profile creating unit 401 (step S1101). More specifically, profiles relating to segments for each hydrophobic amino acid residue present on the surface are created for each protein from protein information stored in the protein information DB 300.

The drug binding site Rx of the target protein Px waits for a specification from the specifying unit 403 (step S1102: No), and if the drug binding site Rx is specified (step S1102: Yes), then a query setting process is carried out by the setting unit 404 (step S1103). More specifically, the profile of the segment Sx having as its geometrical center a hydrophobic amino acid residue located at the drug binding site Rx is extracted from the profile DB 402 along with calculating the distance between the segments Sx.

A search process is then carried out by the search unit 405 (step S1104). More specifically, a search is performed for morphology data identical or similar to the query morphology data Kx from the morphology data Ky having as its vertices the segments of other proteins using the query morphology data Kx set as a result of a query setting process. Finally, the results of the search process are output by the output unit 406 (step S1105).

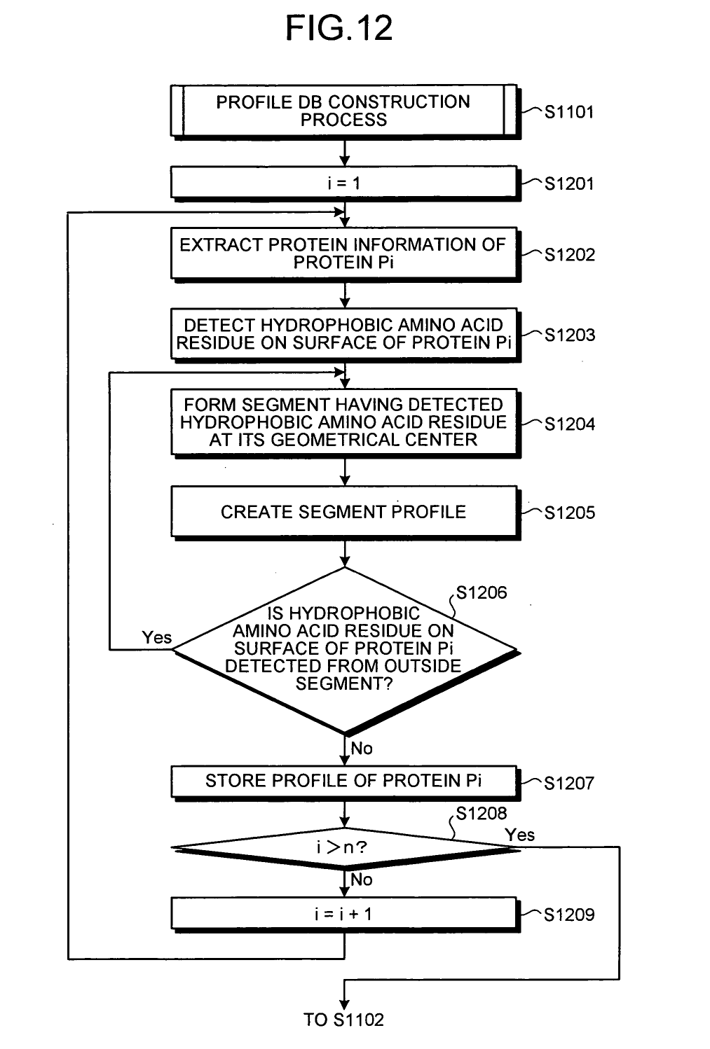

FIG. 12 is a flowchart of the profile DB construction process shown in FIG. 11. Protein ID=i is first set to i=1 (step S1201). Protein information on the protein Pi is then extracted from the protein information DB 300 (step S1202), and a search is performed for hydrophobic amino acid residues on the surface of the protein Pi (step S1203). A segment having as its geometrical center the detected hydrophobic amino acid residue is then formed (step S1204), and a segment profile is created using protein information (step S1205).

A determination is made as to whether the hydrophobic amino acid residue on the surface of the protein Pi has been detected from outside the segment (step S1206). If it has detected (step S1206: Yes), then the procedure returns to step S1204 and a segment is formed. If it has not been detected outside the segment (step S1206: No), then the profile of the protein Pi that has been created is stored in the profile DB 402 (step S1207).

If i>n is not established (step S1208: No), the value of i is incremented by 1 (step S1209), the procedure returns to step S1202 and protein information on the protein Pi is extracted. If i>n is established (step S1208: Yes), then the procedure proceeds to step S1102. Accordingly, profile DB construction processing is completed.

According to the profile DB construction process, as a result of preliminarily forming a segment for each hydrophobic amino acid residue on the surface of each protein Pi and creating a profile for each segment, it is no longer necessary to use protein information having a huge number of calculations in a subsequent surface morphology search process, thereby making it possible to realize a high-speed search.

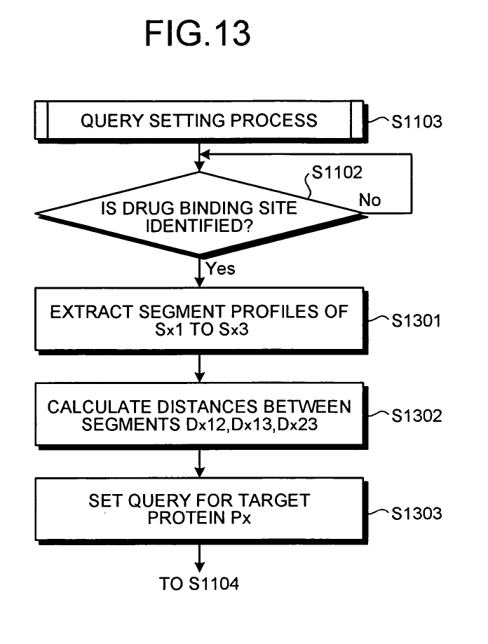

FIG. 13 is a flowchart of the query setting process shown in FIG. 11. As shown in FIG. 7, profiles relating to the segments Sx1 to Sx3 having as their geometrical centers hydrophobic amino acid residues Ax1 to Ax3 located at the drug binding site Rx of the target protein Px are extracted from the profile of the target protein Px (step S1301).

The distances between those segments that compose the drug binding site Rx (Dx12, Dx13, and Dx23 in FIG. 7) are then calculated (step S1302). Morphology data composed of the segments Sx1 to Sx3, their profiles, and the distances between segments Dx12, Dx13, and Dx23 is set for the query (query morphology data Kx (step S1303). The procedure subsequently proceeds to the surface morphology search process (step S1104).

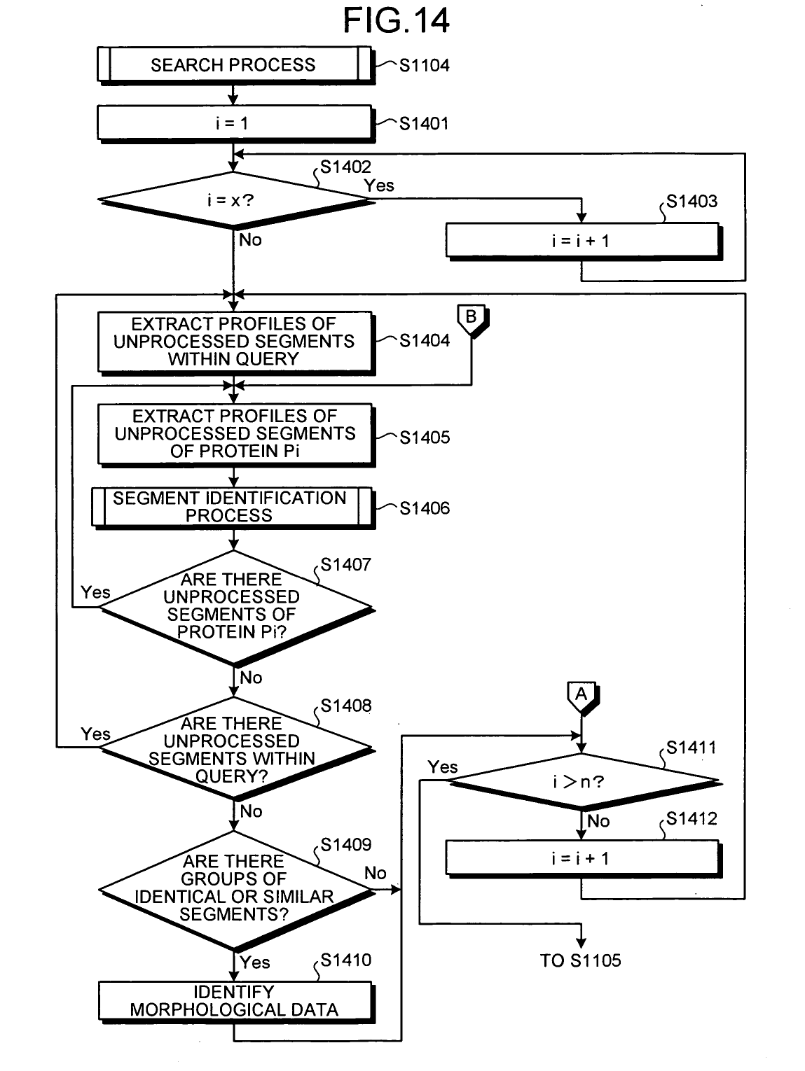

FIG. 14 is a flowchart of the search process shown in FIG. 11. First, the protein ID=i is set to i=1 (step S1401). A determination is made as to whether i=x, namely, whether the protein Pi is the target protein Px (step S1402). If i=x (step S1402: Yes), then i is incremented by 1 (step S1403) and the procedure returns to step S1402. Accordingly, the target protein Px is excluded from the object to be searched.

If it is i≠x (step S1402: No), profiles relating to unprocessed segments in the query are then extracted from the query (step S1404). Profiles relating to unprocessed segments of the protein Pi are then extracted from the profile DB 402 (step S1405).

A segment specification process is then carried out by the segment identifying unit 407 (step S1406). A segment specification process is described later. A determination is then made as to whether there are unprocessed segments of the protein Pi (step S1407). If there are unprocessed segments (step S1407: Yes), the procedure returns to step S1405 and profiles relating to the unprocessed segments are extracted. Accordingly, all unprocessed segments of the protein Pi can be compared for segments present in the query.

If there are no unprocessed segments (step S1407: No), a determination is made as to whether there are unprocessed segments in the query (step S1408). If there are unprocessed segments (step S1408: Yes), the procedure returns to step S1404 and profiles relating to unprocessed segments in the query are extracted.

On the other hand, if there are no unprocessed segments in the query (step S1408: No), a determination is made by the drug binding site identifying unit 408 as to whether there is a group of segments (segments Sy1 to Sy3) that is identical or similar to each of the segments Sx1 to Sx3 that compose query morphology data Ky in the group of segments identified by the segment identification process (step S1409).

If there is no group of identical or similar segments (Sy1 to Sy3) (step S1409: No), the morphology data Ky that is identical or similar to the query morphology data Kx cannot be identified, and the procedure proceeds to step S1411.

On the other hand, if there is a group of identical or similar segments (segments Sy1 to Sy3) (step S1409: Yes), the drug binding site identifying unit 408 determines the group as the morphological data Ky that is similar to identical to the query morphology data Kx (step S1410), and a determination is then made as to whether i>n is established (step S1411).

If i>n is not established (step S1411, No), i is incremented by 1 (step S1412), and the procedure returns to step S1404. If i>n is established (step S1411: Yes), the procedure then proceeds to step S1105. As indicated by the searching process, as a result of including other proteins P1 to Pn (excluding Px) in the search, surface sites that are identical or similar to the drug binding site Rx can be searched from the surface morphologies of other proteins P1 to Pn (excluding Px). Accordingly, it is possible to predict whether another protein P1 to Pn (excluding Px) binds to a designed drug, or in other words, the manner in which other proteins act with respect to a so-called reverse docking.

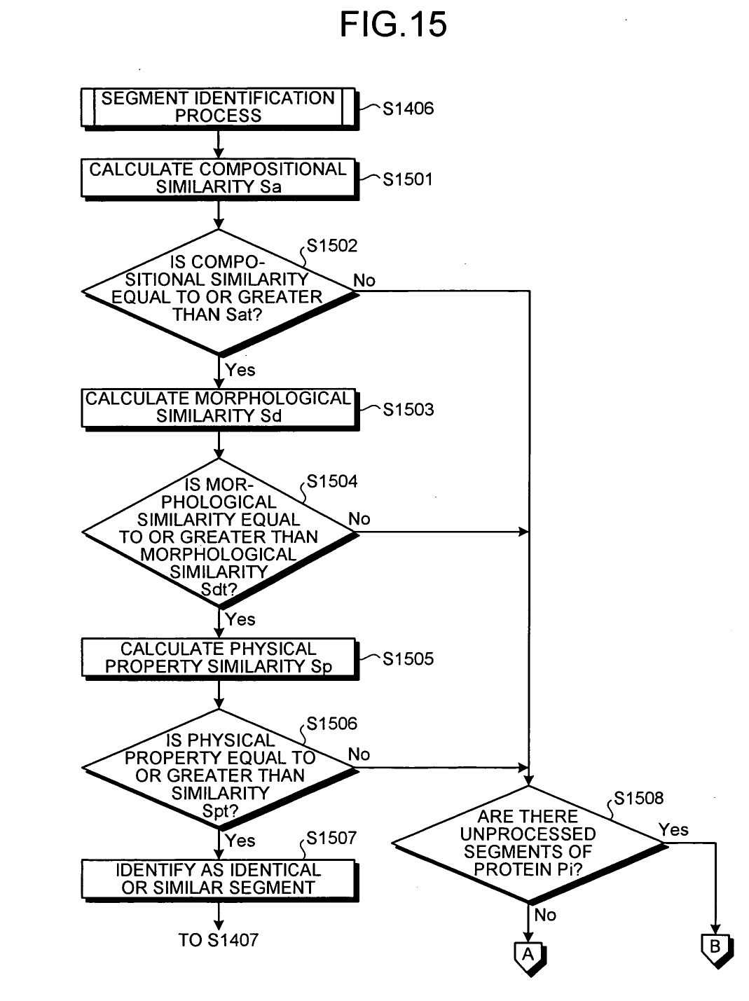

FIG. 15 is a flowchart of the segment specification process shown in FIG. 14. In FIG. 15, the compositional similarity Sa is first calculated by the compositional similarity calculating unit 411 using profiles relating to unprocessed segments in the query and profiles relating to unprocessed segments of the protein Pi (step S1501). A determination is then made by the compositional similarity determining unit 412 as to whether the calculated the compositional similarity Sa is equal to or greater than the predetermined compositional similarity Sat (step S1502).

If it is equal to or greater than the compositional similarity Sat (step S1502: Yes), the morphological similarity Sd is then calculated by the morphological similarity calculating unit 413 (step S1503). A determination is then made by the morphological similarity determining unit 414 as to whether the calculated morphological similarity Sd is equal to or greater than the predetermined morphological similarity Sdt (step S1504).

If it is equal to or greater than the morphological similarity Sdt (step S1504: Yes), then the physical property similarity Sp is calculated by the physical property similarity calculating unit 415 (step S1505). A determination is then made by the physical property similarity determining unit 416 as to whether the calculated physical property similarity Sp is equal to or greater than the predetermined physical property similarity Spt (step S1506).

If it is equal to or greater than the physical property similarity Spt (step S1506: Yes), then the segment is determined as an identical or similar segment (step S1507). Accordingly, an unprocessed segment of the protein Pi that is similar in all aspects of composition, morphology and physical properties is identified as a segment that is identical or similar to an unprocessed segment in the query.

If the calculated compositional similarity is not equal to or greater than the predetermined compositional similarity Sat in step S1502 (step S1502: No), not equal to or greater than the predetermined morphological similarity Sdt (step S1504: No) or not equal to or greater than the predetermined physical property similarity Spt (step S1506: No), then a determination is made as to whether there are unprocessed segments of the protein Pi (step S1508).

If there are no unprocessed segments (step S1508: No), then the procedure proceeds to step S1411 shown in FIG. 14. On the other hand, if there are unprocessed segments (step S1508: Yes), the procedure proceeds to Step S1405 shown in FIG. 14. As a result of the segment specification process, segments can be identified using a more efficient number of calculations than comprehensively calculating the entire surface of the protein Pi.

In this manner, according to this embodiment, surface sites identical or similar to a drug binding site can be searched easily and efficiently from the surface morphologies of other proteins, thereby making it possible to improve search accuracy and the search speed.

Accordingly, when a drug designed based on SBDD binds to a certain protein, adverse side effects can be predicted that have a possibility of being caused by the drug as a result of binding with another protein.

In this embodiment, although segments are formed by using hydrophobic amino acid residues present on the surface of a protein as their geometrical center, the geometrical center can also be a hydrophilic amino acid residue provided hydrophobic amino acid residues are present in the segment.

Although the group of segments that composes the query morphology data Kx includes the three segments Sx1 to Sx3 in this embodiment, the number of segments is preferably three or more for defining a surface. When the group of query segments includes four segments or more in particular, since it becomes possible to define a three-dimensional surface morphology, surface sites that are identical or similar to the drug binding site Rx can be searched with higher accuracy.

Although a drug binding site is searched for with morphology data having segments as its vertices in this embodiment, the drug binding site Rx can also be searched for using morphology data having as its vertices amino acid residues present on the surface of a protein without forming segments. In this case, although segments are not identified by the segment identifying unit 407, a determination is instead made with respect to the uniformity of the types of amino acid residues serving as the vertices of the morphology data. Accordingly, searches can be carried out more easily and the search speed can be improved.

As has been explained above, according to the present invention, whether other proteins bind to a drug designed for a target protein, namely the manner in which other proteins act on the drug, can be easily and efficiently predicted, thereby improving drug research and development.

The search method described in the embodiment can be realized by making a computer, such as a personal computer or a work station, execute a program that is prepared beforehand. The program is stored in a computer-readable recording medium, such as an HD, an FD, a CD-ROM, a MO, a DVD, and the like, and is executed by being read from the recording medium by the computer. The program may be a transmission medium that can be distributed via a network such as the Internet.

According to the present invention, a surface site that is identical or similar to a drug binding site can be searched by comparing surface sites.

According to the present invention, surface sites can be compared in segment units, and there is no need to comprehensively search the entire surfaces of other proteins. Thus, a high-speed search can be realized as a result of reducing the number of calculations.

According to the present invention, a surface site that is identical or similar to a drug binding site can be predicted by identifying a segment that is identical or similar to a segment that composes the vertices of query morphology data from segments that compose the vertices of the morphology data of other proteins.

According to the present invention, candidate segments can be narrowed down and a search speed can be improved according to the internal composition of a segment, namely an incidence frequency of each amino acid residue present in the segment.

According to the present invention, candidate segments can be narrowed down and the search speed can be improved according to the morphology (three-dimensional structure) of amino acid residues within a segment. By using a distance between amino acids for the three-dimensional structure of groups of amino acid residues in particular, the search speed can be improved since segments can be identified independent of the three-dimensional coordinates of amino acids and without having to move or rotate the segments.

According to the present invention, a segment that is easily bound by a drug in the same manner as a drug binding site can be identified according the physical properties within the segment, namely elements other than the three-dimensional structure of amino acid residues within the segment.

According to the present invention, a similarity in the three-dimensional morphology of surface sites can be identified.

According to the present invention, by using hydrophobic amino acid residues involved with a drug binding site, hydrophilic amino acid residues that react easily with water can be removed, and a surface site that is identical or similar to a drug binding site can be identified with high accuracy.

According to the present invention, morphology data for which the vertices of morphology data are the same can be identified from among other proteins according to the identity of the types of amino acid residues since the vertices of morphology data are the amino acid residues. Thus, the search speed can be improved as compared with the case of using segments.

According to the present invention, whether other proteins bind to a drug that has been designed for a target protein, namely the manner in which other proteins act on the drug, can be predicted easily and efficiently.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A search device for searching a specific surface site of protein, comprising:
a database that stores morphology data of a plurality of first surface sites of a first protein and a plurality of second surface sites of a second protein;
a specifying unit that specifies one of the first surface sites as a drug binding site;
a searching unit that searches one of the second surface sites, which is any one of a surface site identical to the drug binding site and a surface site similar to the drug binding site, as a probable drug binding site based on the morphology data stored in the database; and
an output unit that outputs the probable drug binding site.

2. The search device according to claim 1, further comprising:
an extracting unit that extracts morphology data of the drug binding site from the database; and
a creating unit that creates a query based on the morphology data extracted from the database, wherein the searching unit searches the probable drug binding site based on the query and the morphology data stored in the database.

3. The search device according to claim 1, wherein
each of the first surface sites includes a plurality of first segments,
each of the second surface sites includes a plurality of second segments, and
the searching unit searches the probable drug binding site by calculating a similarity between a first morphology data of each of the first segments of the drug binding site, the first morphology data being included in the query, and a second morphology data of each of the second segments of the second surface sites, the second morphology data being stored in the database.

4. The search device according to claim 3, wherein the searching unit includes a compositional-similarity calculating unit that calculates a compositional similarity between each of the first segments and each of the second segments based on an incidence frequency of amino acid residue located within a segment.

5. The search device according to claim 3, wherein the searching unit includes a morphological-similarity calculating unit that calculates a morphological similarity between each of the first segments and each of the second segments based on a distance between amino acid residues located within a segment.

6. The search device according to claim 3, wherein the searching unit includes a physical-property-similarity calculating unit that calculates a morphological similarity between each of the first segments and each of the second segments based on a physical property of amino acid residue located within a segment.

7. The search device according to claim 6, wherein the physical property includes information on fluctuations in temperature of the amino acid residue.

8. The search device according to claim 6, wherein the physical property includes information on an amount of electrical charge of the amino acid residue.

9. The search device according to claim 3, wherein the searching unit searches the probable drug binding site by calculating a similarity between a first arrangement of the first segments in the drug binding site and a second arrangement of the second segments in each of the second surface sites.

10. The search device according to claim 3, wherein each of the first segments and the second segments is a three-dimensional sphere having an amino acid residue at its geometrical center.

11. The search device according to claim 10, wherein the amino acid residue is a hydrophobic amino acid residue.

12. The search device according to claim 1, wherein
each of the first surface sites includes a plurality of first amino acid residues,
each of the second surface sites includes a plurality of second amino acid residues, and
the searching unit searches the probable drug binding site by calculating a similarity between each of the first amino acid residues of the drug binding site and each of the second amino acid residues of each of the second surface sites.

13. A search method of searching a specific surface site of protein using a database that stores morphology data of a plurality of first surface sites of a first protein and a plurality of second surface sites of a second protein, the search method comprising:
specifying one of the first surface sites as a drug binding site;
searching one of the second surface sites, which is any one of a surface site identical to the drug binding site and a surface site similar to the drug binding site, as a probable drug binding site based on the morphology data stored in the database; and
outputting the probable drug binding site.

14. A computer-readable recording medium that stores therein a computer program for searching a specific surface site of protein using a database that stores morphology data of a plurality of first surface sites of a first protein and a plurality of second surface sites of a second protein, wherein the computer program causes a computer to execute:
specifying one of the first surface sites as a drug binding site;
searching one of the second surface sites, which is any one of a surface site identical to the drug binding site and a surface site similar to the drug binding site, as a probable drug binding site based on the morphology data stored in the database; and
outputting the probable drug binding site.
